(19) United States
(12) Patent Application Publication
(10) Pub. No.: US 2025/0104374 A1
(43) Pub. Date: Mar. 27, 2025

(54) INFORMATION PROCESSING SYSTEM, METHOD OF INFORMATION PROCESSING SYSTEM, INFORMATION PROCESSING APPARATUS, AND STORAGE MEDIUM

(71) Applicant: CASIO COMPUTER CO., LTD., Tokyo (JP)

(72) Inventor: Takaharu ASHIKAGA, Tokyo (JP)

(73) Assignee: CASIO COMPUTER CO., LTD., Tokyo (JP)

(21) Appl. No.: 18/888,279

(22) Filed: Sep. 18, 2024

(30) Foreign Application Priority Data
Sep. 25, 2023 (JP) 2023-159314

(51) Int. Cl. G06T 19/20; G06Q 30/0601; G06T 13/40

(52) U.S. Cl. CPC G06T 19/20; G06Q 30/0621; G06T 13/40; G06T 2219/2004

(57) ABSTRACT

An information processing system includes a plurality of information processing apparatuses, each including at least one memory and at least one processor that executes one or more instructions stored in the at least one memory. The information processing system performs the following, in a case that customization of an object related to a product is performed according to a movement in a virtual space by an avatar corresponding to a user, generates first customization information for specifying content of the customization, and selects and executes according to operation by the user, at least one of a first process that provides the customized object based on the first customization information to the avatar in the virtual space, and a second process that allows the user to acquire in a real world the product corresponding to the customization.

### BACKGROUND OF THE INVENTION

### Field of the Invention

The present disclosure relates to an information processing system, a method of the information processing system, an information processing apparatus and a storage medium including a program.

### Description of the Related Art

For example, as disclosed in JP 2008-217142, conventionally, there is a service provided in a virtual space constructed by a computer, and by moving an avatar in response to the user's operation, it is possible to communicate with other avatars moved by other users and to participate in events and games held in the virtual space. Some of these services allow a user to attach an object of goods, such as clothes or accessories, to the user's avatar.

### SUMMARY OF THE INVENTION

In order to solve the above problems, the information processing system of the present disclosure includes, a plurality of information processing apparatuses, each including at least one memory and at least one processor that executes one or more instructions stored in the at least one memory, wherein the information processing system performs the following, in a case that customization of an object related to a product is performed according to a movement in a virtual space by an avatar corresponding to a user, generates first customization information for specifying content of the customization, and selects and executes according to operation by the user, at least one of a first process that provides the customized object based on the first customization information to the avatar in the virtual space, and a second process that allows the user to acquire in a real world the product corresponding to the customization.

Further features of the present invention will become apparent from the following description of exemplary embodiments (with reference to the attached drawings).

### BRIEF DESCRIPTION OF THE DRAWINGS

FIG. 1 is a diagram showing a configuration of an information processing system.

FIG. 2 is a block diagram showing a functional configuration of a VR server.

FIG. 3 is a diagram illustrating an example of contents of user management data.

FIG. 4 is a block diagram showing a functional configuration of a control apparatus.

FIG. 5 is a block diagram showing a functional configuration of a VR device.

FIG. 6 is a block diagram showing a functional configuration of an EC server.

FIG. 7 is a diagram showing a VR screen.

FIG. 8 is a diagram showing a customization IF.

FIG. 9 is a diagram showing a state in which a short band icon is selected.

FIG. 10 is a diagram showing a state in which a product object is generated in response to a selection of an export button.

FIG. 11 is a diagram contents of first customization data.

FIG. 12 is a diagram showing contents of a customization association table.

FIG. 13 is a diagram showing contents of second customization data.

FIG. 14 is a diagram showing a purchase screen.

FIG. 15 is a diagram showing a purchase screen in which an orientation of a product has been changed.

FIG. 16 is a diagram showing a purchase screen on which a dialog box is displayed.

FIG. 17 is a diagram showing a reception screen displaying a second website.

FIG. 18 is a flowchart illustrating a control procedure for a customization process.

FIG. 19 is a flowchart showing a control procedure for product purchase processing by a CPU of the control apparatus.

FIG. 20 is a flowchart showing a control procedure for product purchase processing by a CPU of the EC server.

FIG. 21 is a flowchart showing a control procedure for a gift product providing process by a CPU of the control apparatus.

FIG. 22 is a flowchart showing a control procedure for a gift product providing process by the CPU of the EC server.

### DETAILED DESCRIPTION OF THE PREFERRED EMBODIMENTS

Hereinafter, embodiments of the present disclosure are described with reference to the drawings.

### Overview of Information Processing System

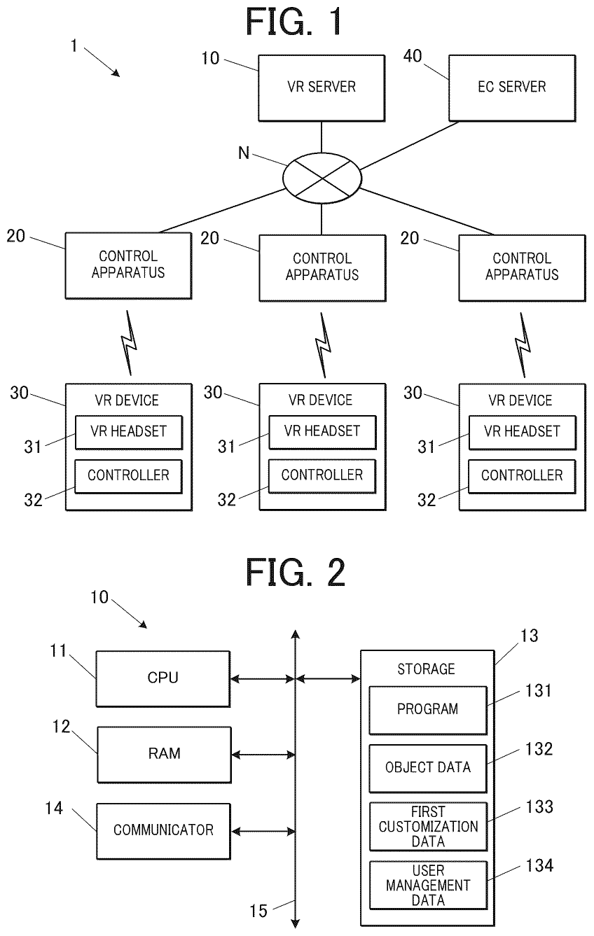

FIG. 1 is a diagram showing a configuration of an information processing system 1.

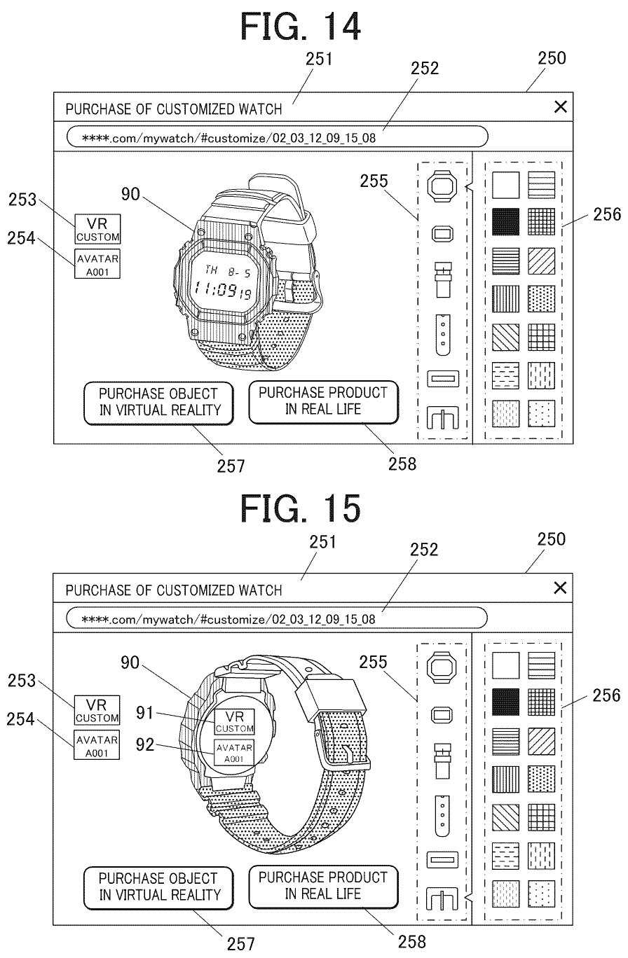

The information processing system 1 includes a VR server 10, a plurality of control apparatuses 20, a plurality of VR devices 30 (terminal devices), and an EC server 40. Each of the VR server 10, the plurality of control apparatuses 20, the plurality of VR devices 30, and the EC server 40 is an aspect of an “information processing apparatus”. Therefore, the configuration consisting of the VR server 10, the plurality of control apparatuses 20, the plurality of VR devices 30, and the EC server 40 is an aspect of the “plurality of information processing apparatuses”. The information processing system 1 provides various services in a three-dimensional virtual space 2 (metaverse) (see FIG. 7) constructed by a computer to a plurality of users who use the information processing system 1. Further, the information processing system 1 can provide a service to the user that applies VR (virtual reality) in a metaverse (hereinafter referred to as “VR service”). VR is a technology that allows the user to experience a virtual world constructed in the virtual space 2 as if it were real. Further, according to the information processing system 1, it is possible to purchase (acquire) a product object 70 (object related to the product) in the virtual space 2 customized by the user (see FIG. 10) or a product 90 in the real world (see FIG. 14) having the same design as the product object 70 on a website of an EC (electronic commerce) service provided by the EC server 40.

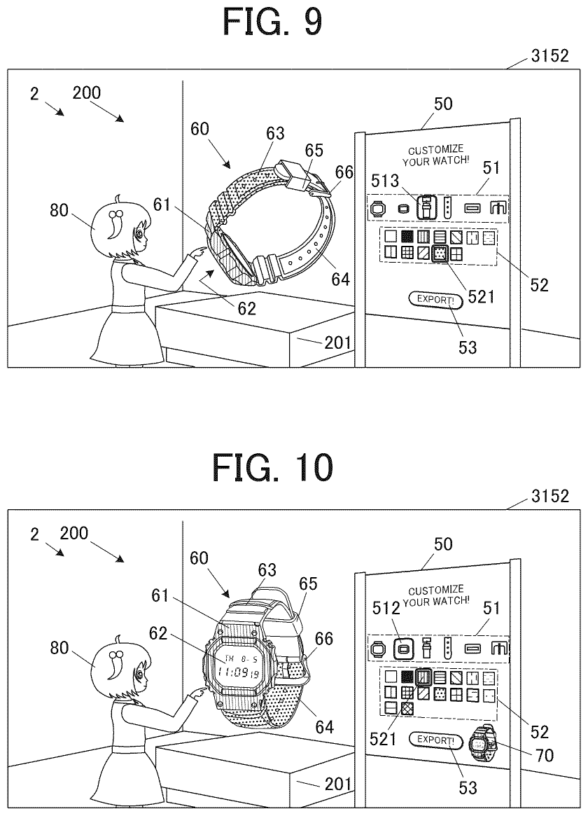

Each user of the information processing system 1 uses one control apparatus 20 and one VR device 30. The control apparatus 20 and the VR device 30 are connected so that data can be transmitted and received by wireless communication. The VR device 30 includes a VR headset 31 (head-mounted device) and a controller 32 worn and used by the user. The VR device 30 detects movement and input operation by the user using the VR headset 31 and the controller 32, and transmits a detection result to the control apparatus 20. The control apparatus 20 transmits data such as a VR screen 3151 (see FIG. 7) and audio of the virtual space 2 to the VR headset 31 in response to the user's movement or input operation detected by the VR device 30, and performs display of the VR screen 3151 and output of the audio. In this way, VR is realized by performing on the VR headset 31 in real time display of the VR screen 3151 of the virtual space 2 or output of the audio according to the user's movement and input operation. In the virtual space 2, a character called an avatar 80 (see FIG. 9 and FIG. 10) moves on behalf of the user. In other words, the VR headset 31 projects in real time the VR screen 3151 of the virtual space 2 viewed from the viewpoint of the avatar 80.

The VR server 10, the plurality of control apparatuses 20, and the EC server 40 are connected by communication via the network N, and data can be transmitted and received from each other. The network N is, for example, but not limited to the Internet.

Hereinafter, each component of the information processing system 1 will be described in detail.

### VR Server Configuration

FIG. 2 is a block diagram showing a functional configuration of the VR server 10.

The VR server 10 includes a CPU 11 (Central Processing Unit), a RAM 12 (Random Access Memory), a storage 13, a communicator 14, a bus 15, and the like. The CPU 11 is an aspect of “at least one processor”. The RAM 12 and the storage 13 are an aspect of “at least one memory”. Each part of the VR server 10 is connected via the bus 15. Note that the VR server 10 may further include an operator, a display, and the like used by an administrator of the VR server 10. The VR server 10 acquires and manages various data necessary for providing the VR service, and transmits it to a plurality of control apparatuses 20 as necessary.

The CPU 11 is a processor that reads and executes the program 131 stored in the storage 13 and performs various arithmetic processes in order to control the operation of each unit of the VR server 10. Note that the VR server 10 may have a plurality of processors (for example, a plurality of CPUs), and a plurality of processes executed by the CPU 11 of the present embodiment may be executed by the plurality of processors. In this case, the plurality of processors may be involved in a common process, or the plurality of processors may independently execute different processes in parallel. The program 131 is an aspect of “one or more instructions”.

The RAM 12 provides a working memory space for the CPU 11 and stores temporary data.

The storage 13 is a non-transitory storage medium that can be read by the CPU 11 as the computer, and stores the program 131 and various data. The storage 13 includes, for example, a non-volatile memory such as an HDD (Hard Disk Drive) or an SSD (Solid State Drive). The program 131 is stored in the storage 13 in the form of a program code that can be read by the computer. Examples of the data stored in the storage 13 include object data 132, first customization data 133 (first customization information), user management data 134, and the like. The object data 132 includes information such as the position and outer appearance of each object in the virtual space 2. The first customization data 133 includes information related to the content of customization of the product object 70 by the user's avatar 80. The first customization data 133 is data received from the control apparatus 20 and stored in the storage 13, and includes data identical to at least a part of the first customization data 233 (see FIG. 4) of the control apparatus 20.

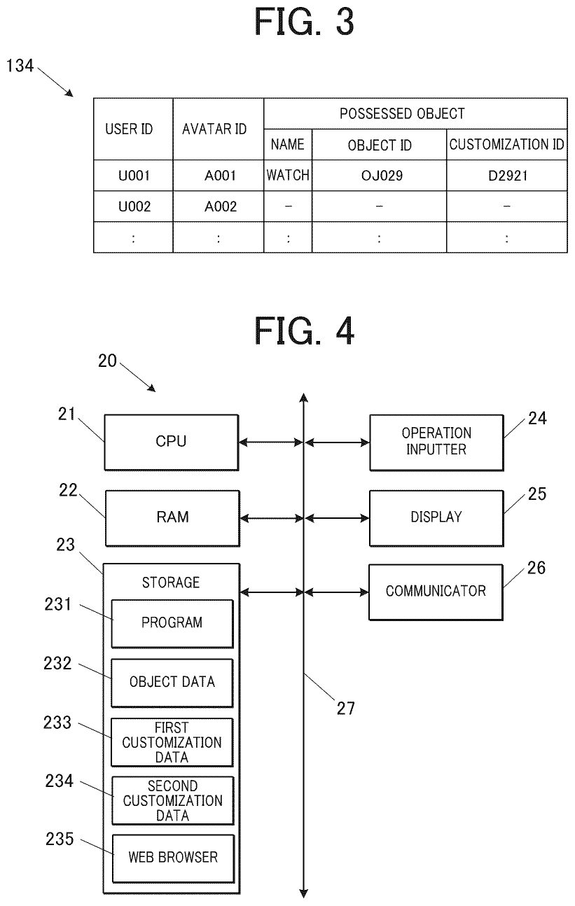

FIG. 3 is a diagram illustrating an example of the contents of the user management data 134.

One data row of user management data 134 corresponds to an account of one user of the information processing system 1. “User ID” in the data row is a unique code assigned to the user. “Avatar ID” is a unique code assigned to the avatar 80 corresponding to the user.

“Possessed object” represents information pertaining to the object possessed by the avatar 80. The “possessed object” includes sub-items such as “name” representing the name of the object, “object ID” which is a unique code assigned to the object, and “customization ID” which is a unique code representing the customization content of the object. The state in which the avatar 80 possesses the object is not limited to the state in which the object is attached, but also includes the state in which the object is held without attaching it. In the example shown in FIG. 3, the avatar 80 having the avatar ID “A001” possesses the product object 70 which is a watch. The product object 70 which is the watch can be worn on a wrist of the avatar 80.

The user management data 134 may include information other than the information illustrated in FIG. 3.

Returning to FIG. 2, the communicator 14 performs communication operation in accordance with a predetermined communication standard. The communicator 14 transmits and receives data between the control apparatus 20 and the EC server 40 via the network N by such communication operation.

### Configuration of Control Apparatus

FIG. 4 is a block diagram showing the functional configuration of the control apparatus 20.

The control apparatus 20 includes a CPU 21, a RAM 22, a storage 23, an operation inputter 24, a display 25, a communicator 26, a bus 27, and the like. The CPU 21 is an aspect of “at least one processor”. The RAM 22 and the storage 23 are aspects of “at least one memory”. Each part of the control apparatus 20 is connected via the bus 27. The control apparatus 20 is, for example, a notebook PC or a stationary PC, but may not be limited thereto, and may be a tablet terminal or a smartphone.

The CPU 21 is a processor that controls the operation of each unit of the control apparatus 20 by reading and executing various programs such as a program 231 and a web browser 235 stored in the storage 23, and performing various arithmetic processes. The program 231 is an aspect of “one or more instructions”. Note that the control apparatus 20 may have a plurality of processors (for example, a plurality of CPUs), and the plurality of processors may execute a plurality of processes executed by the CPU 21 of the present embodiment. In this case, the “processor” is configured by a plurality of processors. In this case, the plurality of processors may be involved in a common process, or the plurality of processors may independently execute different processes in parallel.

The RAM 22 provides a working memory space for the CPU 21 and stores temporary data.

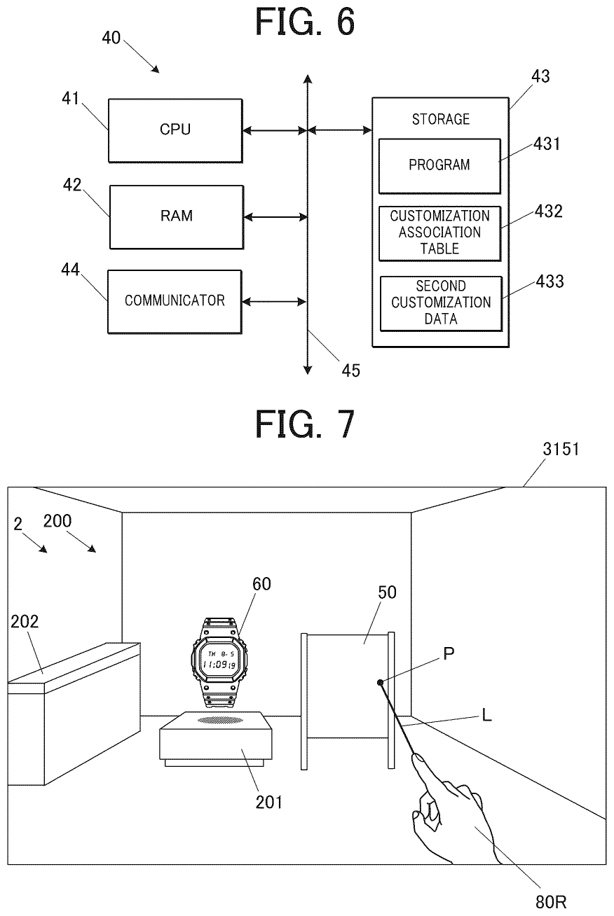

The storage 23 is a non-transitory storage medium that can be read by the CPU 21 as a computer, and stores programs such as the program 231, the web browser 235, and various data. The web browser 235 is a program for displaying a website such as an EC site provided by the EC server 40 in the display 25. The storage 23 includes, for example, non-volatile memory such as an HDD or an SSD. The program is stored in the storage 23 in the form of a computer-readable program code. Examples of the data stored in the storage 23 include object data 232, first customization data 233, and second customization data 234 (second customization information). The object data 232 is data received from the VR server 10 and stored in the storage 23, and includes data identical to at least a part of the object data 132 of the VR server 10. The second customization data 234 is data received from the EC server 40 and stored in the storage 23, and includes data identical to at least a part of the second customization data 433 (see FIG. 6) of the EC server 40.

The operation inputter 24 accepts the user's input operation and outputs an input signal corresponding to the input operation to the CPU 21. The operation inputter 24 includes, for example, an input device such as a keyboard, a mouse, and a touch screen.

The display 25 displays to the user a website such as an EC site, and processing contents and information related to various statuses in the control apparatus 20. The display 25 includes a display device such as a liquid crystal display, for example.

The communicator 26 performs communication operations in accordance with a predetermined communication standard. The communicator 26 transmits/receives data between the VR server 10 and the EC server 40 via the network N by this communication operation. Further, the communicator 26 transmits/receives data by wireless communication with the VR device 30.

### Configuration of VR Device

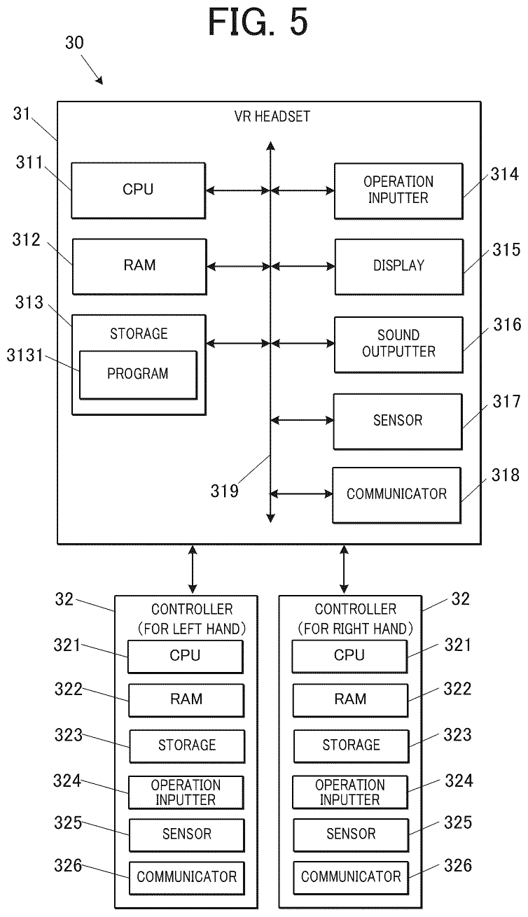

FIG. 5 is a block diagram showing a functional configuration of the VR device 30.

The VR device 30 includes a VR headset 31, a controller 32 for the right hand, and a controller 32 for the left hand. The two controllers 32 are connected to the VR headset 31 wirelessly or wired so as to be able to communicate data. The VR headset 31 is used by attaching it to the user's head. The controller 32 is used by attaching or holding it in the user's hand. The controller 32 corresponds to the “inputter”.

The VR headset 31 includes a CPU 311, a RAM 312, a storage 313, an operation inputter 314, a display 315, a sound outputter 316, a sensor 317, a communicator 318, a bus 319, and the like. The CPU 311 is an aspect of “at least one processor”. The RAM 312 and the storage 313 are an aspect of “at least one memory”. Each part of the VR headset 31 is connected via the bus 319.

The CPU 311 is a processor that controls the operation of each part of the VR headset 31 by reading and executing a program 3131 stored in the storage 313 and performing various arithmetic processes.

The RAM 312 provides a working memory space for the CPU 311 and stores temporary data.

The storage 313 is a non-transitory storage medium that can be read by the CPU 311 as a computer, and stores the program 3131 and various data. The program 3131 is an aspect of “one or more instructions”.

The operation inputter 314 includes various switches, buttons, and the like, accepts the input operation of the user, and outputs an input signal corresponding to the input operation to the CPU 311. The operation inputter 314 corresponds to the “inputter”.

The display 315 displays an image visualized by a user wearing the VR headset 31. The display 315 includes a liquid crystal display, an organic EL display, or the like provided in a position that can be seen by the user wearing the VR headset 31. The image data of the image displayed by the display 315 is transmitted from the control apparatus 20 to the VR headset 31. The display 315 displays the image based on the received image data according to control by the CPU 311.

The sound outputter 316 outputs various sounds recognized by the hearing of the user wearing the VR headset 31 according to the control by the CPU 311.

The sensor 317 detects the movement and direction of the head of the user wearing the VR headset 31. The sensor 317 includes, for example, a 3-axis acceleration sensor that detects acceleration in an orthogonal 3-axis direction, a 3-axis gyro sensor that detects angular velocity around the orthogonal 3-axis, and a 3-axis magnetometer that detects a geomagnetic field in the orthogonal 3-axis direction. The CPU 311 derives the movement and orientation of the user's head based on the acceleration data, angular velocity data, and geomagnetic data received from the sensor 317. The sensor 317 can accept the movement and direction of the user as a user operation, and corresponds to the “inputter”.

The communicator 318 performs communication operation in accordance with a predetermined communication standard. The communicator 318 transmits and receives data by wireless communication between the controller 32 and the control apparatus 20 by this communication operation.

The controller 32 includes a CPU 321 that collectively controls the operation of the controller 32, a RAM 322 that provides a memory space for work to the CPU 321, a storage 323 in which a program and data necessary for executing the program are stored, an operation inputter 324, a sensor 325, a communicator 326 that performs data communication with the VR headset 31, and the like.

The operation inputter 324 (inputter) includes various switches, buttons, operation keys, and the like, accepts the user's input operation, and outputs an input signal corresponding to the input operation to the CPU 321. Further, the operation inputter 324 may be able to separately detect the movement of each finger of the user.

The sensor 325 includes a 3-axis acceleration sensor, a 3-axis gyro sensor, and a 3-axis magnetometer, and detects the movement and direction of the user's hand holding or wearing the controller 32. The configuration and operation of the sensor 325 may be the same as, for example, the sensor 317 of the VR headset 31.

The configuration of the VR device 30 is not limited to the above.

For example, the VR device 30 may further include an auxiliary sensor device that is not held or attached to the user. This sensor device may be installed on a floor or the like, for example, and may be a device that optically detects the movement of the user or the movement of the VR headset 31 and the controller 32 by laser scanning or the like.

Further, when it is not necessary to separately detect the movement of both hands, one controller 32 may be omitted. Further, the controller 32 may be omitted when the VR headset 31 can detect the necessary user movement and input operation.

FIG. 6 is a block diagram showing a functional configuration of the EC server 40.

The EC server 40 includes a CPU 41, a RAM 42, a storage 43, a communicator 44, a bus 45, and the like. The CPU 41 is an aspect of “at least one processor”. The RAM 42 and the storage 43 are an aspect of “at least one memory”. Each part of the EC server 40 is connected via the bus 45. The CPU 41 corresponds to “an information processing means (information processor) for executing a process related to an electronic commerce transaction of a product”. Note that the EC server 40 may further include an operator, a display, and the like used by the administrator of the EC server 40. The EC server 40 acquires and manages various data necessary for providing the EC service, and transmits it to the control apparatus 20 as necessary.

The CPU 41 is a processor that controls the operation of each part of the EC server 40 by reading and executing the program 431 stored in the storage 43 and performing various arithmetic processes. Note that the EC server 40 may have a plurality of processors (for example, a plurality of CPUs), and the plurality of processors may execute a plurality of processes executed by the CPU 41 of the present embodiment. In this case, the plurality of processors may be involved in a common process, or the plurality of processors may independently execute different processes in parallel. The program 431 is an aspect of “one or more instructions”.

The RAM 42 provides a working memory space for the CPU 41 and stores temporary data.

The storage 43 is a non-transitory storage medium that can be read by the CPU 11 as a computer, and stores the program 431 and various data. The storage 43 includes, for example, a non-volatile memory such as an HDD or SSD. The program 431 is stored in the storage 43 in the form of a program code that can be read by a computer. Examples of the data stored in the storage 43 include a customization association table 432 and second customization data 433. The contents of these data will be described later.

The communicator 44 performs communication operations in accordance with a predetermined communication standard. The communicator 44 transmits/receives data between the VR server 10 and the control apparatus 20 via the network N by this communication operation.

### Operation of Information Processing System

Next, the operation of the information processing system 1 will be described.

In the following description, the operating subject is the CPU 11 of the VR server 10, the CPU 21 of the control apparatus 20, the CPU 311 of the VR headset 31, the CPU 321 of the controller 32, or the CPU 41 of the EC server 40. However, for the convenience of description, the VR server 10, the control apparatus 20, the VR headset 31, the controller 32, or the EC server 40 may be described as the operating subject.

Further, the user movement and input operation detected by the VR device 30 are collectively referred to as “user operation” below. That is, the “user operation” of the present embodiment includes an input operation detected by the operation inputter 314 of the VR headset 31 and the operation inputter 324 of the controller 32, and the movement detected by the sensor 317 of the VR headset 31 and the sensor 325 of the controller 32.

In the following description, the image display operation in the VR headset 31 will be mainly described, and other operations such as sound output will be omitted.

### <Basic Operation Related to VR>

When the user starts using the VR service provided by the information processing system 1, the user attaches the VR headset 31 and the controller 32 of the VR device 30, and performs a predetermined operation for starting the VR service. In response to the operation, authentication information of the user is transmitted from the control apparatus 20 to the VR server 10, and when the user is authenticated by the VR server 10, an authentication result is returned from the VR server 10 to the control apparatus 20. Then, the control apparatus 20 starts providing the VR service to the authenticated user.

When the VR service is started, the control apparatus 20 downloads the object data 232 necessary for displaying the virtual space 2 from the VR server 10 and stores it in the storage 23. Further, transmission of image data in the virtual space 2 from the control apparatus 20 to the VR headset 31 of the VR device 30 is started. Here, the image data of the virtual space 2 seen from the viewpoint of the avatar 80 at a predetermined initial position in the virtual space 2 is transmitted to the VR headset 31. The image data is generated based on object data 232 and the like. In response to the transmission of the image data, the display 315 of the VR headset 31 starts displaying the VR screen 3151 of the virtual space 2 based on the received image data.

FIG. 7 is a diagram illustrating the VR screen 3151.

In the present embodiment, a case where the user and the avatar 80 receive a service at the virtual store 200 of the watch provided in the virtual space 2 will be described with reference to an example. The virtual store 200 customizes and sells the product object 70 which is the watch. The VR screen 3151 includes the image representing the inside of the virtual store 200 in three dimensions. Inside the virtual store 200, a customization IF (interface) 50, a sample object 60, a pedestal 201 of the sample object 60, a purchase counter 202 for performing a product purchase procedure, and the like are provided. The position, orientation, color, shape, and the like of each object in the virtual store 200 are determined based on the information of the object data 232.

The customization IF 50 is an interface operated by the avatar 80 to customize the design of the product object 70 which is the watch.

The sample object 60 is an enlarged model object of the product object 70 which is the watch. The sample object 60 reflects the contents of the customization performed by the customization IF 50. The sample object 60 is disposed in a space on the pedestal 201.

When the virtual store service is started, detection of the user's operation by the VR device 30 is started, and the detection result is continuously transmitted to the control apparatus 20. The control apparatus 20 controls the movement of the avatar 80 in the virtual store 200 (virtual space 2) in response to the received user operation. That is, the control apparatus 20 converts the received user operation into the movement of the avatar 80 in the virtual store 200, and specifies and updates the position, orientation, posture, and the like of the avatar 80 in the virtual store 200 in real time. Then, the control apparatus 20 generates image data of the virtual store 200 viewed from the viewpoint of the updated position and orientation of the avatar 80 and transmits the image data to the VR headset 31. The generation and transmission of this image data is performed repeatedly at a predetermined frame rate. The display 315 of the VR headset 31 displays the VR screen 3151 at the above frame rate based on the received image data of the virtual store 200. Thereby, the user wearing the VR headset 31 can visualize the inside of the virtual store 200 in real time from the viewpoint of the avatar 80 that travels and moves in the virtual store 200 according to his or her own operation. Further, the control apparatus 20 transmits information such as the position, orientation, and posture of the avatar 80 to the VR server 10.

### <Movement Related to Customizing Product Object>

As shown in FIG. 7, in the virtual store 200, a virtual line L extends from a fingertip of the right hand 80R of the avatar 80, and a pointer P is generated at an intersection of the virtual line L and the object. By performing a predetermined operation with the pointer P aligned with the desired target position, a target in the virtual store 200 can be selected. When the user wants to customize the design of the product object 70, the user operates the customization IF 50 by the movement of the avatar 80 using the pointer P.

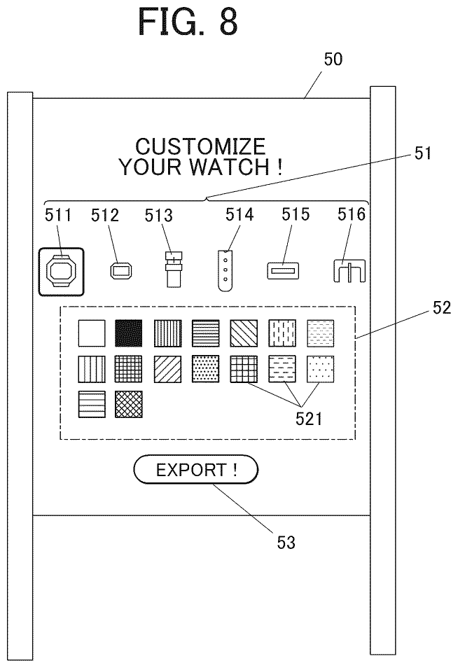

FIG. 8 is a diagram showing a customization IF 50.

The customization IF 50 is a plate-shaped object in a form of a standing sign. The customization IF 50 is provided with a target selection IF 51, a color selection IF 52, and an export button 53.

The target selection IF 51 is an interface for selecting a component which is a target to be customized among the plurality of components (plurality of parts) constituting the product object 70. The target selection IF 51 of the present embodiment includes, as customization targets of the watch, a bezel icon 511 for selecting a bezel 61, a face icon 512 for selecting a face 62, a short band icon 513 for selecting a short band 63, a long band icon 514 for selecting a long band 64, a loop icon 515 for selecting a loop 65 and a buckle icon 516 for selecting a buckle 66. Each of the icons 511 to 516 can be selected using the pointer P described above. In the example shown in FIG. 8, one selected icon (here, the bezel icon 511) is framed. However, it is not limited to this, and may be displayed, for example, in such a way that only the selected icon is lit and the remaining icons are turned off.

Note that the component as the target to be customized is an example, and it is possible to set components other than the above as the target to be customized. For example, in addition to the loop icon 515 corresponding to a single loop, a loop icon corresponding to a triple loop may be displayed, and the shape of the loop may be selected from single or triple by selecting one of the loop icons.

The color selection IF 52 is an interface for specifying the color of the component selected in the target selection IF 51. The color selection IF 52 includes a plurality of color palettes 521 corresponding to any of a plurality of colors that are different from each other. Each color palette 521 can be selected using the pointer P described above. The type of color palette 521 included in the color selection IF 52 can be switched corresponding to the icon selected among the icons 511 to 516 of the target selection IF 51. That is, the color palette 521 of colors preset for the component corresponding to the selected icon is displayed in the color selection IF 52.

The color of the component corresponding to the icons 511 to 516 can be changed by selecting any of the color palette 521 of the color selection IF 52 while any of the icons 511 to 516 is selected in the target selection IF 51. The change in the color of the component is reflected in the sample object 60.

In the sample object 60, the color of each component is white in a default state at the time of starting customization, and the color of each component is changed at any time according to the operation of the customization IF 50. The sample object 60 is arranged so that the face 62 on which the time is displayed faces a predetermined front direction of the virtual store 200 in the default state. FIG. 7 shows a sample object 60 in its default state.

FIG. 9 is a diagram illustrating a state in which the short band icon 513 is selected.

In FIG. 9, for convenience of explanation, a third-party viewpoint screen 3152 displaying the inside of the virtual store 200 from a third-party perspective is shown. The third-party viewpoint screen 3152 is an image that views the virtual store 200 from a predetermined point on the virtual space 2, which is different from the viewpoint of the avatar 80. The user can switch between the VR screen 3151 and the third-party viewpoint screen 3152 by performing a predetermined operation.

When any of the icons 511 to 516 of the target selection IF 51 is selected, the orientation of the sample object 60 is changed so that the component corresponding to the selected icon is easily visible from the avatar 80 (user). In the example shown in FIG. 9, the sample object 60 is rotated so that the short band 63 of the sample object 60 faces the front direction in response to the short band icon 513 being selected.

Further, in FIG. 9, the color of the short band 63 is specified as yellow with the short band icon 513 selected. Correspondingly, the color of the short band 63 of the sample object 60 is colored yellow.

Thus, the color of the component of the sample object 60 can be changed by selecting the color palette 521 of the color selection IF 52 while selecting any of the icons 511 to 516 of the target selection IF 51. By repeating this operation, the design can be customized by changing the color of each component of the sample object 60. In other words, when the customization IF 50 is operated by the avatar 80, the settings related to the sample object 60 and the product object 70 are changed so that the sample object 60 and the product object 70 are customized according to the content of the operation.

FIG. 9 illustrates a method for customizing the color of each component, but other design elements of each component, such as the shape, can be customized by the same method. For customization of the shape, in addition to the color selection IF 52, a shape selection IF (not illustrated) for selecting the shape is displayed.

The object data 232 received from the VR server 10 includes image data of customization contents that can be selected for each component of the sample object 60 in advance. The control apparatus 20 combines the image data, and is able to display the sample object 60 in which the color and/or shape has been changed.

Further, it may be possible to jointly customize the design by a plurality of avatars 80 corresponding to a plurality of users.

After customizing the design as described above, by selecting the export button 53, the product object 70 having a design reflecting the contents of the customization is generated in the virtual space 2.

FIG. 10 is a diagram illustrating a state in which the product object 70 is generated in response to the selection of the export button 53.

When the export button 53 is selected, the product object 70 having the same design as the sample object 60 at that time is generated in the vicinity of the export button 53 and displayed (output). Depending on the generation of the product object 70, the sample object 60 may return to the default color scheme shown in FIG. 7.

The generated product object 70 is held or attached to a predetermined part of the avatar 80 when the avatar 80 performs a predetermined movement. When the avatar 80 holding or attaching the product object 70 moves in the virtual space 2, the position and orientation of the product object 70 in the virtual space 2 follow the position and orientation of the attachment site of the avatar 80.

When generating the product object 70, the control apparatus 20 first generates the first customization data 233 that specifies the customization content of the generated product object 70 and stores it in the storage 23.

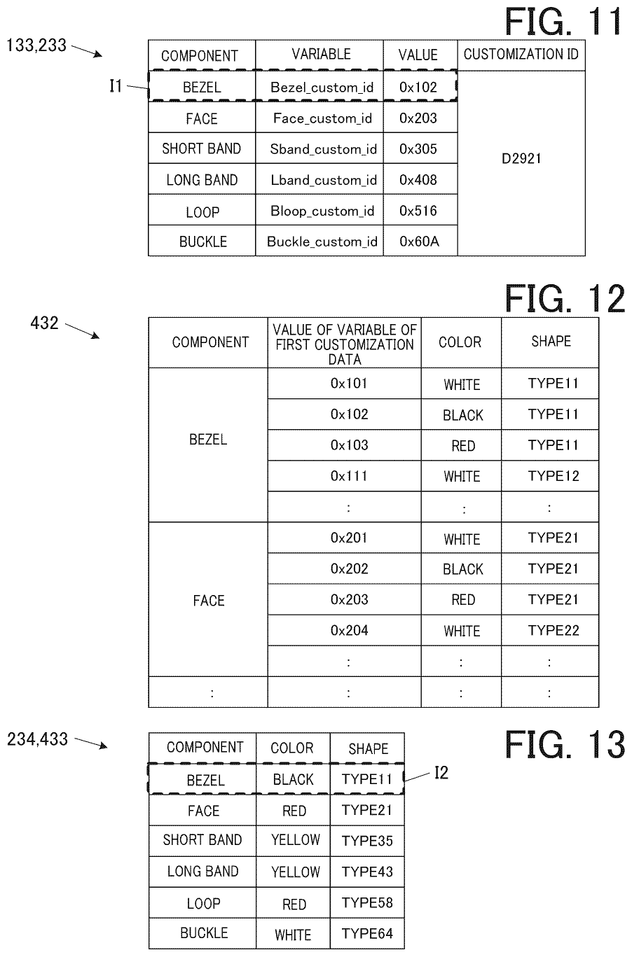

FIG. 11 is a diagram showing the contents of the first customization data 133 and 233.

The first customization data 133, 233 include six variables corresponding to six components (bezel, face, short band, long band, loop and buckle), values assigned to each variable, and unique customization ID information assigned to the customization content. “Component”, “variable” and “value” corresponding to one component correspond to “first part design information I1”. The value assigned to each variable represents the customization of the corresponding component. For example, a third digit “1” in a hexadecimal value “0x102” assigned to the variable “Bezel_custom_id” corresponding to the bezel is a code indicating that it is a bezel customization content, and the last two digits “02” are codes indicating the predetermined bezel customization contents (here, it is a combination of color and shape). The same is true for variables in other components. The third digit of the value of the variable is any of “1” to “6”, and each indicates customization contents of the bezel, face, short band, long band, loop, and buckle, respectively.

Instead of setting a variable separately for each component as shown in FIG. 11, a plurality of values with different third digits may be assigned in the variables common to the components, and the value corresponding to each component may be determined by the third digit.

The generated first customization data 233 is transmitted from the control apparatus 20 to the VR server 10 and stored as the first customization data 133.

The object data 232 received from the VR server 10 includes image data of customization contents that can be selected for each component of the product object 70 in advance. Each component of the product object 70 may be a reduction in the size of each component of the sample object 60, and the image data of each component of the product object 70 and the sample object 60 may be shared. The control apparatus 20 generates image data of the entire product object 70 by combining the image data of each component of “shape” and “color” specified in the first customization data 233. Then, the control apparatus 20 transmits the image data to the VR device 30 and the image data is displayed.

Alternatively, the VR server 10 that received the first customization data 133 may generate image data of the product object 70 having the customization contents specified by the first customization data 133 and transmit it to the control apparatus 20.

### <Operation Related to Purchase of Product Object or Corresponding Product>

The user makes the avatar 80 travel in a state of holding or attaching the generated product object 70 to the purchase counter 202 and performs a predetermined movement (for example, an operation to press the purchase button (not illustrated)). With this, a purchase procedure for purchasing (acquiring) the product object 70 or a real-world watch product 90 that has been customized (corresponding to customization) identical to the product object 70 can be started. When a plurality of customized product objects 70 are generated, the product object 70 located closest to the purchase counter 202 (for example, the product object 70 possessed or worn by the avatar 80) may be determined as a purchase target. When the product object 70 is purchased, the product object 70 is given to the user's avatar 80. That is, as shown in FIG. 3, in the user management data 134, the customized product object 70 is registered in association with the avatar 80 as the possessed object possessed by the avatar 80. The purchased possessed object can be taken out of the virtual store 200 in the virtual space 2, for example. Further, when the product 90 is purchased, the product 90 is delivered to the user's address in the real world.

The above purchase procedure is performed by the control apparatus 20 as a client terminal and the EC server 40. When the purchase procedure is started, the web browser 235 of the control apparatus 20 is activated, and the following process for displaying the purchase screen 250 including a first website 251 (see FIG. 14) is executed on the display 25.

First, the first customization data 233 is transmitted from the control apparatus 20 to the EC server 40. The EC server 40 converts the first customization data 233 into the second customization data 433 with reference to the customization association table 432. The process related to this conversion corresponds to “third process for converting the first customization information into the second customization information that can be interpreted by the information processing means”.

FIG. 12 is a diagram illustrating the contents of the customization association table 432.

In the customization association table 432, the “color” and “shape” of the component are registered in association with the value of the variable of the first customization data 233 for each component. The “color” and “shape” may be in any form as long as the CPU 41 of the EC server 40 can be interpreted as a design element of the component.

Note that the customization association table 432 may be one in which the design code of the component is associated corresponding to the value of the variable of the first customization data 233. In this case, by referring to another table data, it may be possible to specify “color” and “shape” corresponding to the design code.

The EC server 40 converts the first customization data 233 to the second customization data 433 based on the correspondence between the value of the variable of the first customization data 233 in the customization association table 432 and the “color” and “shape”.

FIG. 13 is a diagram showing the contents of the second customization data 433.

The second customization data 433 includes customization elements, i.e., “color” and “shape” information for each of the six components. The “component”, “color” and “shape” corresponding to one component correspond to “second part design information I2”. The second part design information I2 corresponding to each component of the second customization data 433 is obtained by extracting “color” and “shape” corresponding to the value of the variable of each component of the first customization data 233 in the customization association table 432. Therefore, the second customization data 433 includes information the same specifying customization content as the first customization data 233 and can be interpreted by the CPU 41 of the EC server 40.

The EC server 40 transmits the generated second customization data 433 to the control apparatus 20 together with the content data (HTML, CSS, image data, etc.) necessary for the display of the first website 251. The control apparatus 20 stores the received second customization data 433 as the second customization data 234 in the storage 23. The control apparatus 20 allows the display 25 to display the purchase screen 250 including the first website 251 on the web browser 235 based on the received content data and the second customization data 234. Thereafter, the user removes the VR headset 31 and the controller 32 and operates the operation inputter 24 while visually recognizing the display 25 of the control apparatus 20.

FIG. 14 is a diagram illustrating a purchase screen 250.

The purchase screen 250 is a screen for displaying the first website 251 for purchasing the product object 70 or the product 90. On the purchase screen 250, the product 90 as the purchase target, a first URL 252 of a first website 251, a first indicator 253, a second indicator 254, a target selection icon 255, a color selection icon 256, an object purchase button 257, and a product purchase button 258 are displayed.

Each component in the image of the product 90 has a design that reflects the customization contents specified by the received second customization data 234. The image of each component is drawn based on the contents of the second customization data 234 by, for example, executing a program such as JavaScript (registered trademark) included in the content data of the first website 251. In FIG. 14, the image of the product 90 in the real world is used, but the image of the product object 70 in the virtual space 2 may be used instead.

The first indicator 253 is an indicator indicating that customization has been performed in the virtual space 2. In the example shown in FIG. 14, the first indicator 253 includes, but is not limited to, the characters “VR CUSTOM”.

The second indicator 254 is an indicator representing the avatar 80 that performed the customization. In the example shown in FIG. 14, the second indicator 254 includes, but is not limited to, the avatar ID of the avatar 80. For example, the image of the avatar 80 may be displayed as the second indicator 254.

Note that one or both of the first indicator 253 and the second indicator 254 may be omitted.

The target selection icon 255 is a group of icons for specifying the component as the customization target when the design of the component is further customized on the purchase screen 250. The six icons of the target selection icon 255 correspond to the six icons included in the target selection IF 51 of the customization IF 50.

The color selection icons 256 are a group of icons for specifying the color of the component in the customization of the design of the component on the purchase screen 250. The color selection icon 256 includes, for example, a color palette identical to the color palette 521 included in the color selection IF 52 of the customization IF 50.

FIG. 15 is a diagram illustrating the purchase screen 250 in which the orientation of the product 90 has been changed.

In FIG. 15, the orientation of the product 90 is changed so that the buckle of the product 90 is on the front side in response to the buckle icon being selected among the target selection icons 255. As shown in FIG. 15, the back lid of the main body of the product 90 (or the product object 70) is provided with a first indicator 91 indicating that customization has been performed in the virtual space 2 and a second indicator 92 representing the avatar 80 that performed the customization. The first indicator 91 is identical to the first indicator 253, and the second indicator 92 is identical to the second indicator 254. The first indicator 91 and the second indicator 92 are not only on the purchase screen 250, but are also engraved on the back lid of the product object 70 in the virtual space 2 and on the back lid of the product 90 in the real world. That is, the CPU 41 of the EC server 40 registers the setting for engraving the first indicator 91 and the second indicator 92 on the product object 70 and the product 90 in setting information (not illustrated) regarding the product object 70 and the product 90. The process pertaining to this registration corresponds to “a process for assigning at least one of the first indicator and second indicator to an object or product”. Note that one or both of the first indicator 91 and/or the second indicator 92 may be omitted.

In the above, the image of the component is changed on the control apparatus 20 side by JavaScript or the like so that the component of the product 90 (or product object 70) on the purchase screen 250 becomes the design reflecting the customization contents, but it is not limited to this method. For example, the EC server 40 may transmit data of the component design reflecting the customization content to the control apparatus 20, and the control apparatus 20 may display the image of each component of the product 90 reflecting the customization content based on the received data.

Further, separate first websites 251 and first URLs 252 may be generated to correspond to each of the plurality of customization contents in which at least some component designs differ from each other (that is, for each customization ID). Then, the first URL 252 may be specified on the web browser 235 of the control apparatus 20 to display the first website 251 and the purchase screen 250 including the image of the product 90 reflecting the customization content. The individual first website 251 and the first URL 252 may be generated by the EC server 40 each time based on, for example, the received first customization data 233, or possible combinations of the first website 251 and the first URL 252 may be generated in advance and stored in the storage 43 of the EC server 40.

In the examples shown in FIG. 14 and FIG. 15, the first URL 252 of the first website 251: includes a string of characters “02_03_12_09_15_08” at the end. This string corresponds to the last two digits of the value of each variable in the first customization data 233 of FIG. 11. By defining the first URL 252 with such rule, the EC server 40 can easily specify the first URL 252 of the first website 251 of the corresponding design from the first customization data 233.

Based on the received first customization data 233, the EC server 40 generates the second customization data 433 including the information of the first URL 252 and transmits the data to the control apparatus 20. The control apparatus 20 specifies the first URL 252 included in the received second customization data 433 (second customization data 234) on the web browser 235 and is able to display the purchase screen 250 including the first website 251.

By selecting the object purchase button 257 on the purchase screen 250 of FIG. 14 or FIG. 15, the process for purchasing the product object 70 in the virtual space 2 (providing the product object 70 to the avatar 80) can be started.

Further, by selecting the product purchase button 258, the process for purchasing the product 90 in the real world can be started.

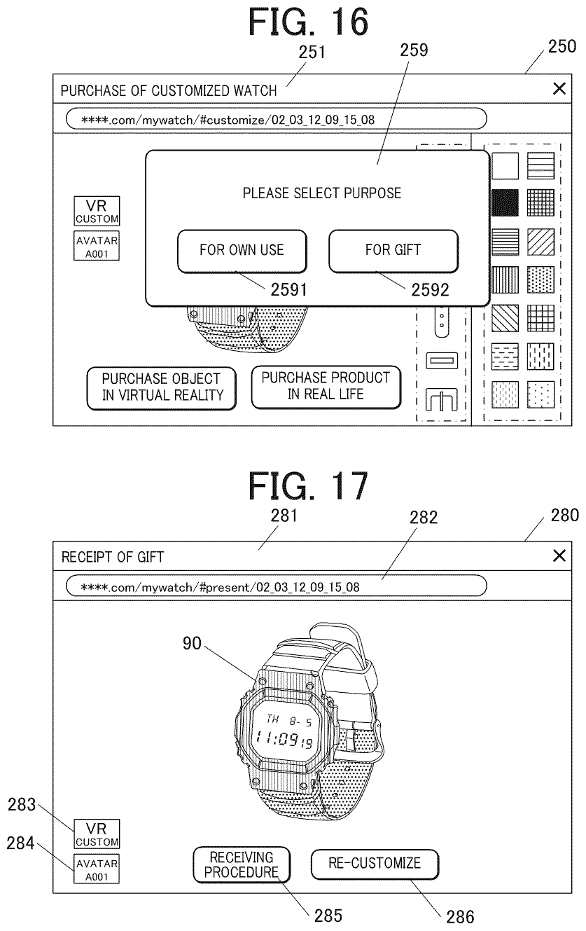

When the operation of selecting the object purchase button 257 or the product purchase button 258 is performed, as shown in FIG. 16, a dialog box 259 for inquiring the purpose of the product object 70 or product 90 to be purchased is displayed on the purchase screen 250. In the present embodiment, the purpose is either “for one's own use” for the user's own use, or “for gift” for the user to give (transfer) to a predetermined target person. In the dialog box 259, an own use button 2591 for declaring that it is “for one's own use” and a gift button 2592 for declaring that it is “for gift” are displayed.

When the own use button 2591 is selected, a process for the user to purchase the product object 70 or the product 90 for himself is started.

When the product object 70 is purchased, the EC server 40 executes a payment process in a predetermined manner, and the VR server 10 associates and registers (provides) the product object 70 with the user's avatar 80 in the user management data 134.

When purchasing the product 90, the control apparatus 20 accepts input of delivery information such as a delivery address of the product 90, and the EC server 40 executes the payment process in a predetermined manner (for example, by electronic payment using credit card information). Thereafter, in the real world, the product 90 is delivered to the delivery address.

On the other hand, when the gift button 2592 is selected, regardless of whether the product object 70 or the product 90 is purchased, the EC server 40 generates a second URL 282 of a second website 281 or information to specify the second URL 282 for a target person to receive (acquire) the gift (product object 70 or product 90). Here, the information for specifying the second URL 282 may be, for example, a barcode, a two-dimensional code, or a ticketing code that can obtain the second URL 282 by decoding.

FIG. 17 is a diagram illustrating a receiving screen 280 displaying a second website 281.

The receiving screen 280 is displayed on the display 25 when the second URL 282 is input on the web browser 235 or the above two-dimensional code or the like is read by a predetermined method in the control apparatus 20 used by the target person who received the gift. On the receiving screen 280, the product 90 (or product object 70) that is the gift, the second URL 282 of the second website 281, a first indicator 283, a second indicator 284, a receiving button 285, and a re-customization button 286 are displayed. The first indicator 283 and the second indicator 284 are the same indicator as the first indicator 253 and the second indicator 254 shown in FIG. 14. Further, although not shown in FIG. 17, the same indicator as the first indicator 91 and the second indicator 92 shown in FIG. 15 is applied to the back lid of the product 90 (or the product object 70).

When the receiving button 285 is selected, a process for the target person to receive the product object 70 or the product 90 is started.

When the gift is the product object 70, the VR server 10 associates and registers (provides) the product object 70 with the avatar corresponding to the target person in the first customization data 133.

When the gift is the product 90, the control apparatus 20 accepts input of delivery information such as the delivery address of the product 90, and the product 90 is delivered to the delivery address in the real world.

On the other hand, when the re-customization button 286 is selected, a process for the target person to re-customize the product 90 (or the product object 70) is started. The method of re-customization is not particularly limited, but for example, on the receiving screen 280, the same customization icon group as the target selection icon 255 and the color selection icon 256 in the purchase screen 250 of FIG. 14 may be displayed. The re-customization may be performed in response to the operation on the icon group. When an operation for performing re-customization is performed, the control apparatus 20 generates third customization data (third customization information) (not illustrated) that specifies the contents of re-customization in response to the operation. The third customization data for the product 90 can be in the same format as, for example, the second customization data 234 shown in FIG. 13. Further, the third customization data for the product object 70 can be in the same format as, for example, the first customization data 233 shown in FIG. 11. The third customization data in the same format as the first customization data 233 can be generated as follows. First, data in the same format as the second customization data 234 is generated. Then, inverse conversion is performed with the “color” and “shape” of the data to the value of the variable of the first customization data 233 based on the customization association table 432.

When the receiving button 285 is selected after the third customization data is generated, a process for the target person to acquire the product object 70 or the product 90 that has been re-customized based on the third customization data is executed. In addition, when the product object 70 or the product 90 is re-customized, information indicating that the re-customization has been performed may be sent to the target person who sent the gift. Specifically, information indicating that re-customization has been performed is sent so that it can be viewed in an e-mail application, SNS application, or the like (not shown) of the target person's control apparatus 20. In this case, information indicating that re-customization has been performed may be sent when one of the customization icon groups is selected, or the receiving button 285 is selected after the above selection (after the operation of re-customizing the color or shape).

### <Customization Process>

Next, a customization process, a product purchase process, and a gift product providing process executed in the information processing system 1 in order to realize the above operation will be described.

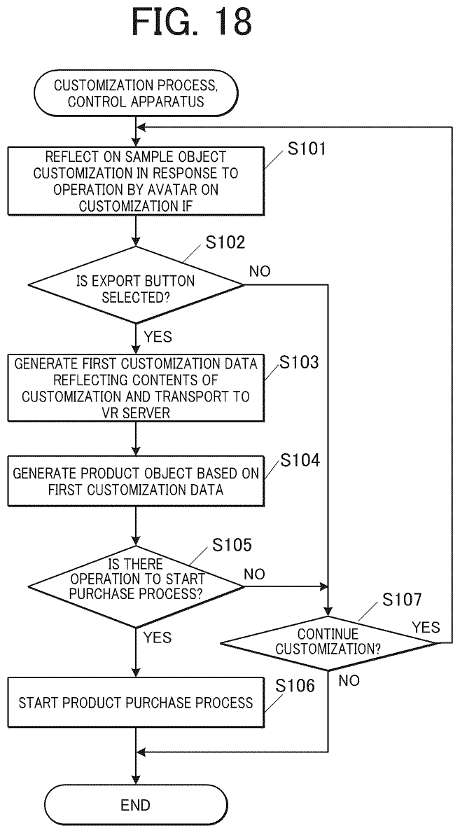

FIG. 18 is a flowchart illustrating a control procedure for a customization process.

The customization process is executed by the CPU 21 of the control apparatus 20 when the VR service for the user is started. Note that at least a part of the customization process may be executed by the CPU 11 of the VR server 10.

When the customization process is started, the CPU 21 of the control apparatus 20 reflects the customization according to the operation of the avatar 80 with respect to the customization IF 50 in the sample object 60 (step S101). The CPU 21 determines whether or not the operation for selecting the export button 53 has been performed (step S102), and when it is determined that the operation has not been performed (“NO” in step S102), the process proceeds to step S107. When it is determined that an operation for selecting the export button 53 has been performed (“YES” in step S102), the CPU 21 generates the first customization data 233 reflecting the contents of the customization and transmits it to the VR server 10 (step S103). The CPU 21 generates the product object 70 of customization contents based on the first customization data 233 and displays it in the VR headset 31 (step S104).

The CPU 21 determines whether or not an operation has been performed by the avatar 80 to start the purchase process of the product object 70 or the product 90 (step S105). Here, the CPU 21 determines that the above operation has been performed when the avatar 80 possessing or attaching the product object 70 performs a predetermined movement at the purchase counter 202. When it is determined that an operation for starting the purchase process has been performed (“YES” in step S105), the CPU 21 starts the product purchase process described later (step S106).

On the other hand, if it is determined that the operation for starting the purchase process has not been performed (“NO” in step S105), or if it is determined that the operation for selecting the export button 53 in step S102 has not been performed (“NO” in step S102), the CPU 21 determines whether or not customization by the avatar 80 is continued (step S107). When it is determined that customization is continued (“YES” in step S107), the CPU 21 returns the process to step S101. When it is determined that the customization is not continued (“NO” in step S107) or when step S106 is completed, the CPU 21 terminates the customization process.

### <Product Purchase Process>

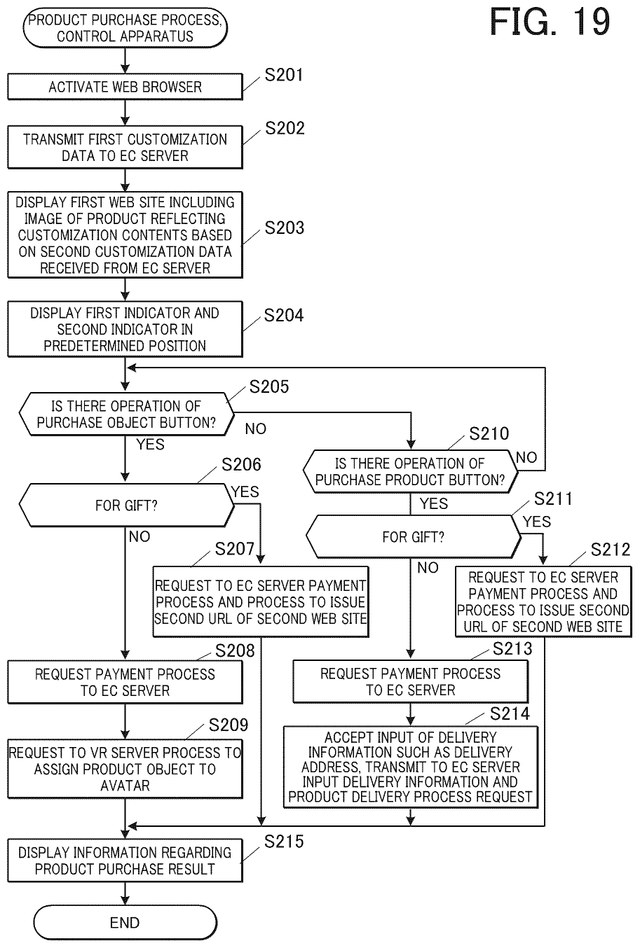

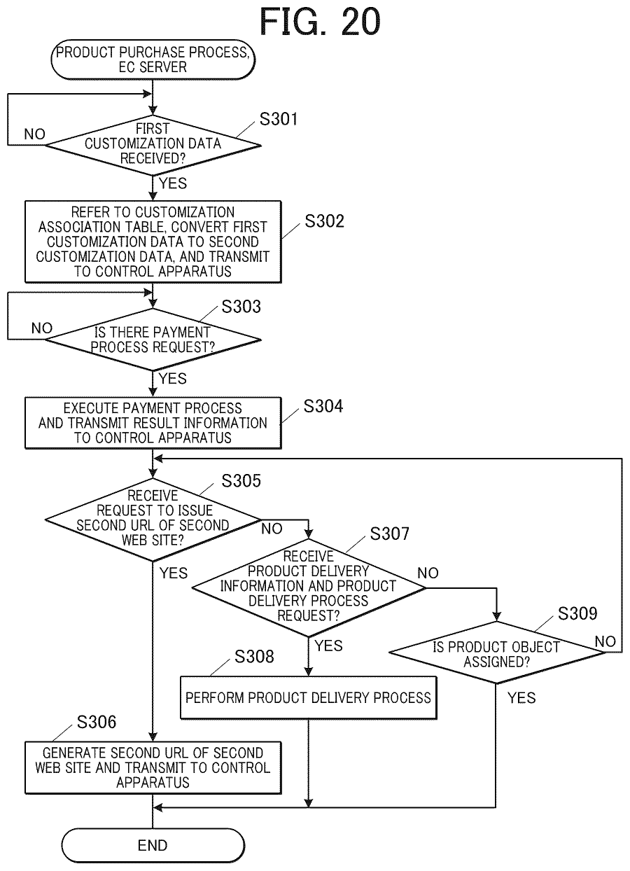

Next, a product purchase process executed when the user purchases the product object 70 or the product 90 will be described. Hereinafter, a process executed by the CPU 21 of the control apparatus 20 (FIG. 19) and a process executed by the CPU 41 of the EC server 40 (FIG. 20) will be described separately. FIG. 19 and FIG. 20 are examples of processing shared by the control apparatus 20 and the EC server 40, and are not limited thereto. For example, at least a part of the product purchase process shown in FIG. 19 may be executed by the CPU 41 of the EC server 40, and at least a part of the product purchase process shown in FIG. 20 may be executed by the CPU 21 of the control apparatus 20.

FIG. 19 is a flowchart illustrating a control procedure for a product purchase process by the CPU 21 of the control apparatus 20.

When the product purchase process is started, the CPU 21 of the control apparatus 20 activates the web browser 235 (step S201) and transmits the first customization data 233 to the EC server 40 (step S202). When the CPU 21 receives the second customization data 234 from the EC server 40, the CPU 21 displays the first website 251 including the image of the product 90 (or product object 70) in which the customization is reflected on the purchase screen 250 based on the second customization data 234 (step S203). Further, the CPU 21 causes the first indicator 253 and the second indicator 254 shown in FIG. 14 to be displayed at a predetermined position on the purchase screen 250, and the CPU 21 attaches the first indicator 91 and the second indicator 92 shown in FIG. 15 to the back lid of the product 90 (or product object 70) and displays the above (step S204).

When the CPU 21 determines that an operation has been performed to select the object purchase button 257 for purchasing the product object 70 in the virtual space (“YES” in step S205), the CPU 21 displays the dialog box 259 and determines whether or not the product 90 (or the product object 70) is for a gift according to the selection status of the own use button 2591 and the gift button 2592 (step S206). When the gift button 2592 is selected and it is determined that the product 90 (or the product object 70) is for a gift (“YES” in step S206), the CPU 21 requests to the EC server 40 the payment process and the issuing process to issue the second URL 282 of the second website 281 for receiving the gift (step S207).

On the other hand, when the own use button 2591 is selected and it is determined that the product 90 (or the product object 70) is for the user himself (“NO” in step S206), the CPU 21 requests the EC server 40 to perform the payment process (step S208). Further, the CPU 21 requests the VR server 10 to perform a process of providing the product object 70 to the avatar 80 (step S209).

In step S205, if it is determined that the operation of selecting the object purchase button 257 has not been performed (“NO” in step S205), the CPU 21 determines whether or not the operation of selecting the product purchase button 258 for purchasing the product 90 in the real world has been performed (step S210). When it is determined that the operation has not been performed (“NO” in step S210), the CPU 21 returns the process to step S205. When it is determined that the operation has been performed (“YES” in step S210), the CPU 21 displays a dialog box 259 to determine whether or not it is for a gift (step S211). When the gift button 2592 is selected and it is determined that the product 90 (or the product object 70) is for a gift (“YES” in step S211), the CPU 21 requests to the EC server 40 the payment process and the issuing process to issue the second URL 282 of the second website 281 for receiving the gift (step S212).

In step S210, when an operation is performed to select a product purchase button 258 for purchasing the product 90 in the real world, for example, before executing the process of step S211, it is possible to determine whether the product 90 of the current customized content can be manufactured at this time. Specifically, the CPU 21 acquires inventory information (inventory information for each of the plurality of parts) for each of the plurality of components constituting the product 90 from the EC server 40. Based on the inventory information, the CPU 21 determines whether or not the product 90 of the current customization content (the product 90 composed of the component indicated by the customization content) includes the component which is not in stock. If it is determined that a component that is not in stock is included in the above determination, the CPU 21 outputs information indicating that “production is not possible” and terminates the flow of the product purchase process. In this case, after returning to the flow of the customization process, the CPU 21 may output information to the user that customization is performed again, and return to step S101.

On the other hand, when the own use button 2591 is selected and it is determined that the product 90 (or product object 70) is for the user himself (“NO” in step S211), the CPU 21 requests the EC server 40 to perform the payment process (step S213). Further, the CPU 21 accepts input of delivery information such as the delivery address, and transmits the input delivery information and the product delivery processing request to the EC server 40 (step S214).

When any one of steps S207, S209, S212, or S214 is completed, the CPU 21 displays information related to the result of the product purchase on the purchase screen 250 (step S215). For example, when step S207 or S212 is executed, the CPU 21 displays the second URL 282 of the second website 281 (or a two-dimensional code for acquiring the second URL 282) on the purchase screen 250. Further, when step S209 or S214 is executed, the CPU 21 displays a notification on the purchase screen 250 indicating that the attachment of the product object 70 to the avatar 80 or the delivery process of the product 90 has been completed.

When step S215 is completed, the CPU 21 terminates the product purchase process.

The processing of steps S201 to S209 and S215 in the product purchase process of FIG. 19 corresponds to “the first process for providing the product object customized based on the first customization information to the avatar in the virtual space”. Further, the processing of steps S201 to S204 and S210 to S215 corresponds to “second processing for the user to acquire a product customized based on the first customization information in the real world”.

FIG. 20 is a flowchart illustrating a control procedure for product purchase processing by the CPU 41 of the EC server 40.

When the product purchase process is started, the CPU 41 repeatedly determines whether or not the first customization data 233 has been received from the control apparatus 20 (step S301). When it is determined that the first customization data 233 has been received (“YES” in step S301), the CPU 41 converts the first customization data 233 to the second customization data 433 by the method described above, referring to the customization association table 432, and transmits the result to the control apparatus 20 (step S302). Specifically, the CPU 41 converts a plurality of first part design information Il of the first customization data 233 into a plurality of second part design information I2, and generates second customization data 433 that includes a plurality of second part design information I2. The process in step S302 corresponds to “third process for converting the first customization information into second customization information that can be interpreted by the information processing means (information processor) that executes the processing related to the electronic commerce of the product”.

The CPU 41 repeatedly determines whether or not the payment processing request has been made from the control apparatus 20 (step S303). When it is determined that a payment processing request has been made (“YES” in step S303), the CPU 41 executes the payment process and transmits the result information (such as the success or failure of the payment) to the control apparatus 20 (step S304).

When the CPU 41 determines that it has received a request to issue the second URL 282 of the second website 281 (“YES” in step S305), the second URL 282 of the second website 281 (or a two-dimensional code capable of acquiring the second URL 282) is generated, and transmitted to the control apparatus 20 (step S306).

When it is determined that the issuance request of the second URL 282 has not been received (“NO” in step S305), the CPU 41 determines whether or not the delivery information of the product 90 and the product delivery processing request have been received (step S307). When it is determined that the information and the request have been received, the product delivery process for delivering the product 90 to the delivery address is executed based on the contents of the received delivery information (step S308).

When it is determined that the delivery information and the product delivery processing request have not been received (“NO” in step S307), the CPU 41 determines whether or not the process of providing the product object 70 to the avatar 80 has been performed in the VR server 10 (step S309). When it is determined that the process has not been performed (“NO” in step S309), the CPU 41 returns the process to step S305. When it is determined that the process has been performed (“YES” in step S309), or when step S306 or S308 is completed, the CPU 41 terminates the product purchase process.

### <Gift Product Providing Process>

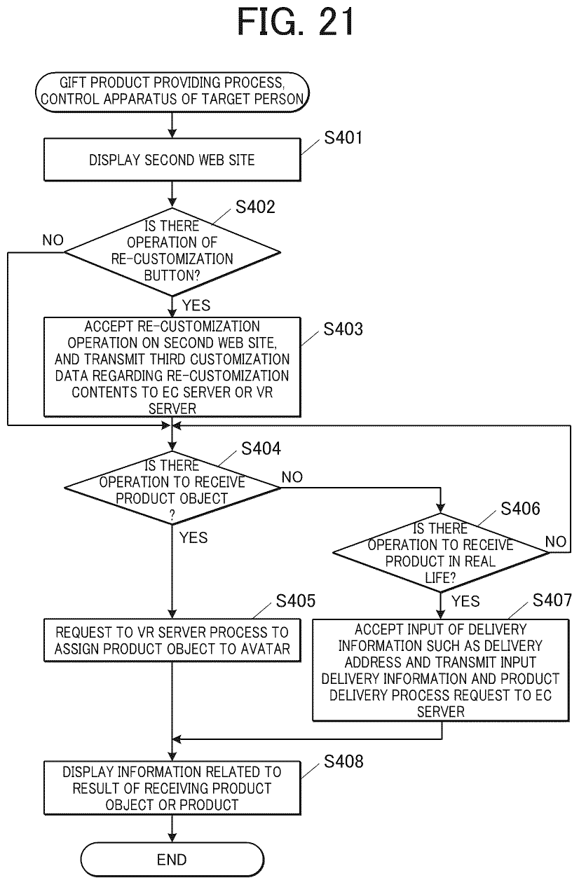

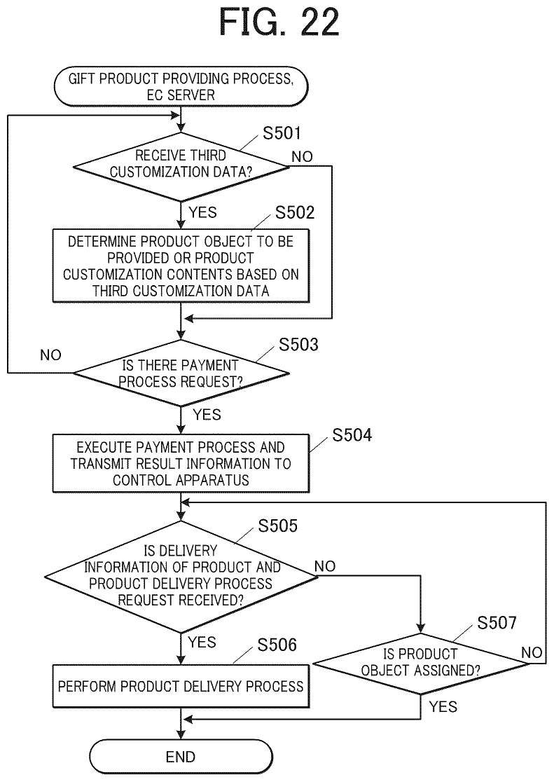

Next, a gift product providing process executed when providing the product object 70 or the product 90 as a gift to the target who receives the gift will be described. Hereinafter, a process executed by the CPU 21 of the target person's control apparatus 20 (FIG. 21) and a process executed by the CPU 41 of the EC server 40 (FIG. 22) will be described. The gift product providing process of FIG. 21 and FIG. 22 corresponds to “a process for the target person to acquire the product object or the product that has been re-customized based on the third customization information”. FIG. 21 and FIG. 22 are examples of processing shared by the control apparatus 20 and the EC server 40, and are not limited thereto. For example, at least a part of the gift product providing process (target person's control apparatus 20) shown in FIG. 21 may be executed by the CPU 41 of the EC server 40, and at least a part of the gift product providing process (EC server 40) shown in FIG. 22 may be executed by the CPU 21 of the control apparatus 20.

FIG. 21 is a flowchart illustrating a control procedure for a gift product providing process by the CPU 21 of the control apparatus 20.

The gift product providing process starts when the web browser 235 is launched in the target person's control apparatus 20 and the second URL 282 of the second website 281 is input, or when the two-dimensional code for acquiring the second URL 282 is read.

When the gift product providing process is started, the CPU 21 displays the receiving screen 280 including the second website 281 on the display 25 (step S401). The CPU 21 determines whether or not an operation for selecting the re-customization button 286 has been performed (step S402). When it is determined that the operation has been performed (“YES” in step S402), the CPU 21 accepts the re-customization operation on the second website 281, generates the third customization data related to the contents of the re-customization, and transmits the data to the EC server 40 (when receiving the product 90) or the VR server 10 (when receiving the product object 70) (step S403).

When it is determined that the receiving target is the product object 70 and that the operation for selecting the receiving button 285 has been performed (“YES” in step S404), the CPU 21 requests the VR server 10 to perform a process of providing the product object 70 to the avatar 80 (step S405).

When branching to “NO” in step S404, the CPU 21 determines whether or not the receiving target is the product 90 and the operation of selecting the receiving button 285 has been performed (step S406). When it is determined that the operation has not been performed (“NO” in step S406), the CPU 21 returns the process to step S404. When it is determined that the operation has been performed (“YES” in step S406), the CPU 21 accepts input of delivery information such as the delivery address, and transmits the input delivery information and the product delivery processing request to the EC server 40 (step S407).

When step S405 or S407 is completed, the CPU 21 displays information related to the result of receiving the product object 70 or the product 90 in the display 25 (step S408), and terminates the gift product providing process.

FIG. 22 is a flowchart showing a control procedure for a gift product providing process by the CPU 41 of the EC server 40.

When the gift product providing process is started, the CPU 41 determines whether or not the third customization data has been received from the control apparatus 20 (step S501). When it is determined that the third customization data has been received (“YES” in step S501), the CPU 41 determines the customization contents of the product object 70 or the product 90 to be provided based on the third customization data (step S502).

When step S502 is terminated, or when it is determined that the third customization data has not been received in step S501 (“NO” in step S501), the CPU 41 determines whether or not the payment processing request has been made (step S503). When the CPU 41 determines that the payment processing request has not been made (“NO” in step S503), the CPU 41 returns the process to step S501, and when it is determined that the payment processing request has been made (“YES” in step S503), the CPU 41 executes the payment process and transmits the result information to the control apparatus (step S504).

The CPU 41 determines whether or not the delivery information of the product 90 and the product delivery processing request have been received (step S505). When it is determined that the information and the request have been received, the product delivery process for delivering the product 90 to the delivery address is executed based on the content of the received delivery information (step S506).

When it is determined that the delivery information and the product delivery processing request have not been received (“NO” in step S505), the CPU 41 determines whether or not the process of providing the product object 70 to the avatar 80 of the target has been performed in the VR server 10 (step S507). When it is determined that the process has not been performed (“NO” in step S507), the CPU 41 returns the process to step S505. When it is determined that the process has been performed (“YES” in step S505) or when step S506 is completed, the CPU 41 terminates the gift product providing process.

### Effects

As described above, in the information processing method according to the present embodiment, when the product object 70 is customized according to the movement in the virtual space 2 of the avatar 80 corresponding to the user, the first customization data 233 for specifying the contents of the customization is generated. At least one of the first process for providing the customized product object 70 based on the first customization data 233 to the avatar 80 in the virtual space 2 (steps S201 and S209 and S215 in FIG. 19), and the second process for allowing the user to acquire in the real world the product 90 corresponding to the customization (steps S201 to S204, S210 to S215) is selected and executed according to the user's operation.

In the technology disclosed in JP 2008-217142 described above, the color and shape of the object of the product cannot be customized according to the user's preference, and there is no means to acquire (for example, purchase) the product in the real world that reflects the customization even if the user desires the customized product. However, according to the present disclosure, by providing the above configuration, the user can freely customize the product object 70 in the virtual space 2, and the user can acquire the product object 70 in which the customization is reflected. Further, it is possible for the user to acquire the product 90 in the real world that has been customized in the same way as the product object 70. By doing so, it is possible to realize a product providing service that stretches across the virtual space and the real world.

Further, in the information processing method, when the first process or the second process is executed, the third process (step S302 in FIG. 20) in which the first customization data 233 is converted into a second customization data 234 that can be interpreted by the CPU 41 of the EC server 40 that executes the process related to the electronic commerce of the product object 70 and the product 90 is performed. Thereby, the contents of the customization of the product object 70 in the virtual space 2 can be specified in the EC server 40 and reflected in the product object 70 and the product 90 provided to the user. The format of the value of the variable representing the content of the customization in the first customization data 133 and 233 may differ for each provider of the VR service, and according to the above method, even if customization is made in the virtual space 2 of the VR service by any provider, it can be interpreted by the EC server 40.

Further, the product object 70 and the product 90 have a plurality of components, and the first customization data 233 includes a plurality of first part design information I1 that specify the design of the plurality of components. In the third process, the information processing method converts the plurality of first part design information I1 of the first customization data 233 into the plurality of second part design information I2 that can be interpreted by the CPU 41 and generates the second customization data 234 that includes the plurality of second part design information I2. Thereby, the customization contents of the design of each component can be interpreted by the EC server 40.

Further, the second customization data 234 includes the first URL 252 of the first website 251 for performing electronic commerce of the customized product object 70 or the product 90 corresponding to the customization, or information for identifying the first URL 252. By transmitting such second customization data 234 to the control apparatus 20, the control apparatus 20 can simply display the first website 251 for purchasing the product object 70 or the product 90.

Further, when an operation is performed by the user to transfer the customized product object 70 or the product 90 corresponding to the customization to a predetermined target person, the information processing method generates the second URL 282 of the second website 281 so that the target person acquires the product object 70 or the product 90 or the information for identifying the second URL 282. Thereby, even if the user does not know personal information such as the delivery address of the target person, the product object 70 or the product 90 can be given to the target person as the gift. In addition, the target person can know information such as the model number and customization contents of the product object 70 or product 90 that the target person received as the gift by the information shown in the second website 281, and the information can be linked to the target person's own account. For example, the product object 70 or product 90 that the target person received as the gift can be added to the history of the products that the target person acquired.

Further, when an operation for re-customizing the product object 70 or the product 90 is performed by the target person after the display of the second website 281, the information processing method generates the third customization data that specifies the contents of the re-customization according to the operation. Then, the information processing method executes a process for the target person to acquire the product object 70 or the product 90 that has been re-customized based on the third customization data. Thereby, the subject person who received the product object 70 or the product 90 as the gift can change the customization content according to preference.

Further, the information processing method performs a process for attaching at least one of the first indicator 91 indicating that the customization has been performed to the customized product object 70 or the product 90 corresponding to the customization in the virtual space 2 and the second indicator 92 representing the avatar 80 that performed the customization. Thereby, it can be grasped from the outer appearance of the product object 70 or product 90 that the customization of the product object 70 or product 90 has been performed in the virtual space 2.

Further, the information processing method displays at least one of the first indicator 253 indicating that the customization has been performed in the virtual space 2 and the second indicator 254 representing the avatar 80 that performed the customization on the first website 251. Thereby, it is possible to display on the first website 251 that the customization of the product object 70 or the product 90 has been performed in the virtual space 2 in a manner that is easy to understand.

Further, the information processing system 1 and the control apparatus 20 according to the present embodiment include the CPU 21. The CPU 21 generates first customization data 233 that specifies the contents of the customization when the product object 70 is customized according to the movement of the avatar 80 corresponding to the user in the virtual space 2. At least one of the first process for providing the product object 70 customized based on the first customization data 233 to the avatar 80 in the virtual space 2, and the second process for allowing the user to acquire the product in the real world corresponding to the above customization is selected and executed according to the user's operation. Thereby, it is possible for the user to acquire the product object 70 in the virtual space 2 and the product 90 in the real world in which customization by the user is reflected.

Further, when the product object 70 is customized in response to the movement of the avatar 80 corresponding to the user in the virtual space 2, the program 231 according to the present embodiment controls the CPU 21 to execute the process in which at least one of the following processes is selected and executed in response to the user operation. The processes are as follows, a process that generates the first customization data 233 specifying the contents of the customization, the first process for providing the customized product object 70 based on the first customization data 233 to the avatar 80 in the virtual space 2, and the second process for having the user acquire the product in the real world corresponding to the customization. Thereby, it is possible for the user to acquire the product object 70 in the virtual space 2 and the product 90 in the real world in which customization by the user is reflected.

### Others

The present disclosure is not limited to the above embodiments and various changes are possible.

For example, the function of the EC server 40 may be integrated into the VR server 10 and the EC server 40 may be omitted. That is, in the VR service (in the virtual space 2), payment processing related to the purchase of the product object 70 or the product 90 and product delivery processing may be executed according to the movement of the avatar 80.

Further, the function of the control apparatus 20 may be integrated into the VR device 30 (for example, the VR headset 31), and the control apparatus 20 may be omitted.

Further, the function of the control apparatus 20 may be integrated into the VR server 10 to omit the control apparatus 20, and the VR service may be executed by the VR server 10 and the VR device 30. In this case, the signal output from the operation inputter 324 and the sensor 325 of the VR device 30 is transmitted to the communicator 14 of the VR server 10 via the communicator 326. The VR server 10 controls the movement of the avatar 80 in the virtual space 2 in response to the received user operation. That is, the VR server 10 performs the same process as the control apparatus 20 described above, generates image data in the virtual space 2, and transmits it to the VR device 30.

Further, in the above embodiment, the purchase process of the product object 70 or the product 90 is executed on the web browser 235 of the control apparatus 20, but if the first website 251 and the second website 281 can be displayed in the VR headset 31 of the VR device 30, the user can execute the purchase process while wearing the VR headset 31.

Further, the user may operate the avatar 80 without wearing the VR headset 31. In this case, instead of the VR headset 31, the image of the virtual space 2 is displayed on a normal display (for example, a liquid crystal display included in the display 25 of the control apparatus 20) provided at a position visible by the user. In this case, the screen displayed may be a VR screen 3151 when the user's movement can be detected by the VR device 30. Further, a third-party viewpoint screen may be displayed instead of the VR screen 3151. For example, the user may move the avatar 80 from a third-party perspective in the virtual space 2 by operating the controller 32.

Further, in the above embodiment, the purchase of either the customized product object 70 or the product 90 is determined according to the selection of the object purchase button 257 or the product purchase button 258 on the purchase screen 250, but is not limited to this aspect. For example, the purchase counter 202 of the virtual store 200 may be provided with two buttons corresponding to the object purchase button 257 and the product purchase button 258. The purchase of either the product object 70 or the product 90 can be determined in response to the avatar 80 performing the movement of pressing either of the above buttons.

Further, in the above embodiment, the web browser 235 is activated in response to the avatar 80 performing a predetermined movement at the purchase counter 202, and the EC server 40 generates the second customization data 234 (433) based on the first customization data 233 at startup. The first website 251 containing the image of the customized product object 70 or the product 90 is displayed on the web browser 235 based on the second customization data 234, but is not limited to this aspect. Alternatively, for example, in response to the avatar 80 performing a predetermined movement at the purchase counter 202, the CPU 41 of the VR server 10 may generate the second customization data 234 based on the first customization data 233 at that time. Then, the VR server 10 may transmit the second customization data 234 to the EC server 40 and/or the control apparatus 20, and may display the first website 251 reflecting the contents of the second customization data 234 on the web browser 235.

Further, the acquisition of the product object 70 or the product 90 is not limited to the purchase for a fee, and may be transferred free of charge.

Further, in the above embodiment, either the product object 70 or the product 90 is to be purchased, but both the product object 70 and the product 90 may be purchasable. In this case, the product object 70 may be provided to the avatar 80 before delivery of the product 90. Further, the product object 70 may be provided to the avatar 80 at a timing consistent with the delivery timing of the product 90.

Further, color and shape are illustrated as customization elements of the design of the components of the product object 70, but the customization elements are not limited thereto, and may include other elements such as patterns.

Further, in the above embodiment, an example has been shown in which the product object 70 or the product 90 given as the gift from the user can be re-customized by the target person of the gift, but instead this, re-customization by the target person may be prohibited. Further, the prohibition of re-customization by the target person of the gift may be the whole (all components) of the product object 70 or product 90, or some of the components in the product object 70 or product 90 may be specified by the person sending the gift as the components that cannot be re-customized. When re-customization is prohibited, among the customization icon groups the same as the target selection icon 255 and the color selection icon 256, the icon corresponding to the component for which re-customization is prohibited is grayed out or hidden on the display 25 of the control apparatus 20 of the target person of the gift. With this, the target person who received the gift can understand that re-customization is prohibited.

In addition, the object for a watch is exemplified as the product object, and a watch is exemplified as the product, but the embodiments are not limited to the above. The present disclosure can be applied to the product object or product of any type of goods.

According to the above description, the HDD and the SSD of the storages 13, 23, and 43 are used as the computer readable medium storing the program regarding the above disclosure but the embodiments are not limited to the above. As the computer-readable medium, it is possible to apply an information storage medium such as a flash memory or a CDROM. A carrier wave is also applied to the present disclosure as the medium to provide data of the program according to the present disclosure through the communication lines.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-159314, filed Sep. 25, 2023 which is hereby incorporated by reference wherein in its entirety.

What is claimed is:

1. An information processing system comprising:
a plurality of information processing apparatuses, each including at least one memory and at least one processor that executes one or more instructions stored in the at least one memory,
wherein the information processing system performs the following,
in a case that customization of an object related to a product is performed according to a movement in a virtual space by an avatar corresponding to a user, generates first customization information for specifying content of the customization, and
selects and executes according to operation by the user, at least one of a first process that provides the customized object based on the first customization information to the avatar in the virtual space, and a second process that allows the user to acquire in a real world the product corresponding to the customization.

2. The information processing system according to claim 1, wherein in a case that the first process or the second process is executed, a third process in which the first customization information is converted into second customization information that can be interpreted by an information processor that performs processing related to electronic commerce of the object and the product is executed.

3. The information processing system according to claim 2, wherein,
the object and the product include a plurality of parts,
the first customization information includes a plurality of first part design information that specifies a design of the plurality of parts, and
in the third process, the plurality of first part design information of the first customization information is converted into a plurality of second part design information that can be interpreted by the information processor, and the second customization information including the plurality of second part design information is generated.

4. The information processing system according to claim 2, wherein the second customization information includes a first URL of a first website that performs the electronic commerce of the object that is customized or the product corresponding to the customization, or information to identify the first URL.

5. The information processing system according to claim 1, wherein in a case that an operation that transfers the customized object or the product corresponding to the customization to a predetermined target person is performed by the user, a second URL of a second website with which the target person acquires the object or the product, or information to specify the second URL is generated.

6. The information processing system according to claim 5, wherein,
in a case that an operation is performed by the target person to re-customize the object or the product after displaying the second website, third customization information that specifies contents of the re-customization is generated in response to the operation, and
a process in which the target person acquires the object or the product that is re-customized based on the third customization information is executed.

7. The information processing system according to claim 1, wherein a process to assign at least one of a first indicator indicating that the customization is made in the virtual space and a second indicator representing the avatar that performed the customization to the object that is customized, or the product corresponding to the customization is executed.

8. The information processing system according to claim 4, wherein at least one of a first indicator representing that the customization is made in the virtual space and a second indicator representing the avatar that performs the customization is displayed on the first website.

9. A method performed by an information processing system comprising a plurality of information processing devices, the method comprising:
in a case that customization of an object related to a product is performed according to a movement in a virtual space of an avatar corresponding to a user, generating first customization information for specifying content of the customization, and
selecting and executing according to operation by the user, at least one of a first process that provides the customized object based on the first customization information to the avatar in the virtual space, and a second process that allows the user to acquire in a real world the product corresponding to the customization.

10. The information processing method according to claim 9, further comprising, in a case that the first process or the second process is executed, executing a third process in which the first customization information is converted into second customization information that can be interpreted by an information processor that performs processing related to electronic commerce of the object and the product.

11. The information processing method according to claim 9, further comprising, in a case that an operation that transfers the customized object or the product corresponding to the customization to a predetermined target person is performed by the user, generating a second URL of a second website with which the target person acquires the object or the product, or information to specify the second URL.

12. The information processing method according to claim 9, further comprising executing a process to assign at least one of a first indicator indicating that the customization is made in the virtual space and a second indicator representing the avatar that performed the customization to the object that is customized, or the product corresponding to the customization.

13. An information processing apparatus comprising:
at least one memory; and
at least one processor that executes one or more instructions stored in the at least one memory,
wherein,
the at least one processor executes the following according to the one or more instructions,
in a case that customization of an object related to a product is performed according to a movement in a virtual space of an avatar corresponding to a user, generates first customization information for specifying content of the customization, and
selects and executes according to operation by the user, at least one of a first process that provides the customized object based on the first customization information to the avatar in the virtual space, and a second process that allows the user to acquire in a real world the product corresponding to the customization.

14. The information processing apparatus according to claim 13, wherein in a case that the first process or the second process is executed, the at least one processor executes a third process in which the first customization information is converted into second customization information that can be interpreted by an information processor that performs processing related to electronic commerce of the object and the product.

15. The information processing apparatus according to claim 13, wherein in a case that an operation that transfers the customized object or the product corresponding to the customization to a predetermined target person is performed by the user, the at least one processor generates a second URL of a second website with which the target person acquires the object or the product, or information to specify the second URL.

16. The information processing apparatus according to claim 13, wherein the at least one processor executes a process to assign at least one of a first indicator indicating that the customization is made in the virtual space and a second indicator representing the avatar that performed the customization to the object that is customized, or the product corresponding to the customization.

17. A non-transitory computer-readable storage medium having a program stored thereon for controlling a computer to perform the following function:
in a case that customization of an object related to a product is performed according to a movement in a virtual space of an avatar corresponding to a user, generating first customization information for specifying content of the customization, and
selecting and executing according to operation by the user, at least one of a first process that provides the customized object based on the first customization information to the avatar in the virtual space, and a second process that allows the user to acquire in a real world the product corresponding to the customization.

18. The storage medium according to claim 17, wherein the program stored thereon controls the computer to perform, in a case that the first process or the second process is executed, executing a third process in which the first customization information is converted into second customization information that can be interpreted by an information processor that performs processing related to electronic commerce of the object and the product.

19. The storage medium according to claim 17, wherein the program stored thereon controls the computer to perform, in a case that an operation that transfers the customized object or the product corresponding to the customization to a predetermined target person is performed by the user, generating a second URL of a second website with which the target person acquires the object or the product, or information to specify the second URL.

20. The storage medium according to claim 17, wherein the program stored thereon controls the computer to perform, executing a process to assign at least one of a first indicator indicating that the customization is made in the virtual space and a second indicator representing the avatar that performed the customization to the object that is customized, or the product corresponding to the customization.
